(19) United States
(12) Patent Application Publication
(10) Pub. No.: US 2024/0286549 A1
(43) Pub. Date: Aug. 29, 2024

(54) INTERIOR REARVIEW MIRROR ASSEMBLY WITH PIVOT MOUNT

(71) Applicant: Magna Mirrors of America, Inc., Holland, MI (US)

(72) Inventors: Darryl P. De Wind, West Olive, MI (US); Austen C. Peterson, Hudsonville, MI (US); Rudy A. Morey, Hudsonville, MI (US); John T. Uken, Jenison, MI (US); Justin E. Sobecki, Rockford, MI (US)

(21) Appl. No.: 18/443,504

(22) Filed: Feb. 16, 2024

Related U.S. Application Data
(60) Provisional application No. 63/513,417, filed on Jul. 13, 2023.
(60) Provisional application No. 63/496,705, filed on Apr. 18, 2023.
(60) Provisional application No. 63/486,476, filed on Feb. 23, 2023.

(51) Int. Cl. B60R 1/04

(52) U.S. Cl. CPC B60R 1/04

(57) ABSTRACT

A vehicular interior rearview mirror assembly includes a mirror head adjustable relative to a mounting assembly. The mounting assembly includes a base portion configured to attach at an interior portion of a vehicle and an arm having a pivot element. The mirror head is adjustably attached at the pivot element of the arm via a ball-and-socket pivot joint. The arm is pivotally attached at the base portion via a uni-axial pivot joint and pivots relative to the base portion about a pivot axis of the uni-axial pivot joint. The uni-axial pivot joint limits pivoting of the arm relative to the base portion about other axes. The uni-axial pivot joint includes a retention mechanism that is configured to retain the arm in a selected position relative to the base portion. The mirror head is adjusted via pivoting of the mirror head at the ball-and-socket pivot joint.

### CROSS REFERENCE TO RELATED APPLICATIONS

The present application claims the filing benefits of U.S. provisional application Ser. No. 63/513,417, filed Jul. 13, 2023, U.S. provisional application Ser. No. 63/496,705, filed Apr. 18, 2023, and U.S. provisional application Ser. No. 63/486,476, filed Feb. 23, 2023, which are hereby incorporated herein by reference in their entireties.

### FIELD OF THE INVENTION

The present invention relates generally to the field of interior rearview mirror assemblies for vehicles.

### BACKGROUND OF THE INVENTION

It is known to provide a mirror assembly that is adjustably mounted to an interior portion of a vehicle, such as via a double ball pivot or joint mounting configuration where the mirror casing and reflective element are adjusted relative to the interior portion of a vehicle by pivotal movement about the double ball pivot configuration. The mirror casing and reflective element are pivotable about either or both of the ball pivot joints by a user that is adjusting a rearward field of view of the reflective element.

### SUMMARY OF THE INVENTION

A vehicular interior rearview mirror assembly includes a mirror head adjustably disposed at a mounting assembly. The mirror head comprises a mirror casing and a mirror reflective element. The mounting assembly comprises (i) a base portion configured to attach at an interior portion of a vehicle equipped with the vehicular interior rearview mirror assembly and (ii) an arm having a single ball member. The mirror head is adjustably mounted at the ball member of the arm via a first pivot joint that comprises a ball-and-socket pivot joint. The arm is pivotally mounted at the base portion via a second pivot joint that provides a horizontal pivot axis that, with the base portion attached at the interior portion of the vehicle, is oriented horizontally. With the base portion attached at the interior portion of the vehicle, the arm is pivoted about the horizontal pivot axis and pivoting about other axes is limited by the second pivot joint.

Optionally, the second pivot joint has a plurality of detents to retain the arm relative to the base portion and to retain the mirror head at a selected one of a plurality of vertical positions relative to the base portion. For example, the arm includes a plurality of detent structures and the base includes a flexible tab that engages one of the detent structures to retain the arm relative to the base portion and to retain the mirror head at the selected one of the plurality of vertical positions relative to the base portion.

These and other objects, advantages, purposes and features of the present invention will become apparent upon review of the following specification in conjunction with the drawings.

### BRIEF DESCRIPTION OF THE DRAWINGS

FIG. 1 is a perspective view of an interior rearview mirror assembly;

FIG. 2 is a perspective view of a single ball mount for an interior rearview mirror assembly;

FIG. 3 is a sectional view of an interior rearview mirror assembly with the single ball mount;

FIG. 4 is a perspective view of a double ball mount for an interior rearview mirror assembly;

FIG. 5 is a sectional view of an interior rearview mirror assembly with the double ball mount;

FIG. 6 is a perspective view of a vertically adjustable single ball mount for an interior rearview mirror assembly;

FIG. 7 is another perspective view of the vertically adjustable single ball mount of FIG. 6;

FIG. 8 is a side view of the vertically adjustable single ball mount of FIG. 6, showing pivoting of the ball member;

FIGS. 9 and 10 are perspective views of the arm and a mounting spring for the vertically adjustable single ball mount of FIG. 6;

FIGS. 11 and 12 are perspective views of an arm and a wedge mount for another vertically adjustable single ball mount;

FIG. 13 is a perspective view of the vertically adjustable single ball mount with the wedge mount of FIGS. 11 and 12;

FIG. 14 is a side view of an interior rearview mirror assembly and another vertically adjustable single ball mount;

FIG. 15 is a perspective view of the interior rearview mirror assembly and vertically adjustable single ball mount of FIG. 14;

FIG. 16 is an exploded view of the interior rearview mirror assembly and vertically adjustable single ball mount of FIG. 14;

FIGS. 17 and 18 are exploded views of the vertically adjustable single ball mount of FIG. 14;

FIG. 19 is a sectional view of the vertically adjustable single ball mount of FIG. 14;

FIG. 20 is another exploded view of the vertically adjustable single ball mount of FIG. 14;

FIGS. 21 and 22 are views of the interior rearview mirror assembly and vertically adjustable single ball mount of FIG. 14, showing a wiring path for electrical connection between the mirror head and a power source of the vehicle;

FIG. 23 is a side view of an interior rearview mirror assembly and another vertically adjustable single ball mount;

FIG. 24 is a perspective view of the interior rearview mirror assembly and vertically adjustable single ball mount of FIG. 23;

FIG. 25 is an exploded view of the interior rearview mirror assembly and vertically adjustable single ball mount of FIG. 23;

FIGS. 26 and 27 are exploded views of the vertically adjustable single ball mount of FIG. 23;

FIG. 28 is a sectional view of the vertically adjustable single ball mount of FIG. 23;

FIG. 29 is another exploded view of the vertically adjustable single ball mount of FIG. 23;

FIG. 30 is another sectional view of the vertically adjustable single ball mount of FIG. 23;

FIG. 31 is a sectional view of an interior rearview mirror assembly with a vertically adjustable double ball mount;

FIG. 31A is an enlarged view of area A in FIG. 31;

FIG. 32 is another sectional view of the interior rearview mirror assembly of FIG. 31;

FIG. 33 is a perspective view of the mounting base of the interior rearview mirror assembly of FIG. 31;

FIG. 34 is a perspective view of the socket of the connecting arm of the interior rearview mirror assembly of FIG. 31 that receives the ball member of the mounting base; and

FIG. 35 is a sectional view of the connecting arm of the interior rearview mirror assembly of FIG. 31 that receives the ball member of the mounting base and the ball member at the mirror head.

### DESCRIPTION OF THE PREFERRED EMBODIMENTS

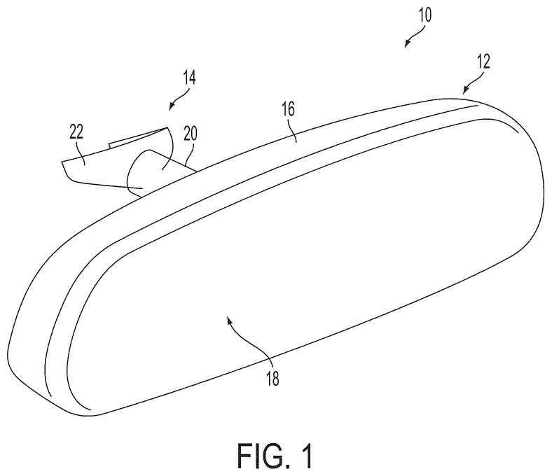

Referring now to the drawings and the illustrative embodiments depicted therein, an interior rearview mirror assembly 10 for a vehicle includes a mirror head 12 adjustably mounted at an interior portion of a vehicle (such as to an interior or in-cabin surface of a vehicle windshield or a headliner of a vehicle or the like) via a mounting structure or mounting configuration or assembly 14 (FIG. 1). The mirror head 12 includes a mirror casing 16 and a reflective element 18 positioned at a front portion of the casing 16. The mirror reflective element may comprise a variable reflectance mirror reflective element that varies its reflectance responsive to electrical current applied to conductive coatings or layers of the reflective element, or the mirror reflective element may comprise a prismatic mirror reflective element. The mounting assembly 14 comprises a vertically adjustable single ball mounting assembly having a ball member portion or arm 20 that is pivotally attached at a base portion 22 and is vertically adjustable or pivotable about a horizontal pivot axis when the base portion 22 of the mounting structure is attached at an interior portion of a vehicle, as discussed below.

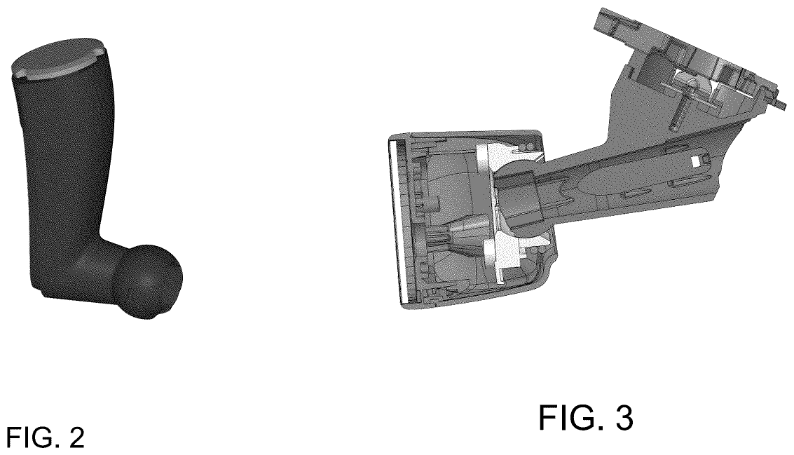

The mirror head of an interior rearview mirror assembly may be adjustably mounted at an interior portion of a vehicle via a single ball or double ball mounting configuration. For example, and as shown in FIGS. 2 and 3, a single ball mount may be provided that has a mounting base or interface that is configured to fit a specific windshield angle, whereby different constructions of the single ball mount are needed for different vehicle windshield angles. The single ball mount provides enhanced vibration performance, a concealed wire harness routing, and a lower part count. To comply with Federal Motor Vehicle Safety Standards (FMVSS), the single ball mount may include a stay or arm that may detach from a windshield button. However, the single ball mount typically must be configured differently to accommodate different windshield angles and different mounting configurations. Thus, a particular single ball mount mirror assembly (designed for a particular vehicle) usually cannot be installed in different vehicles.

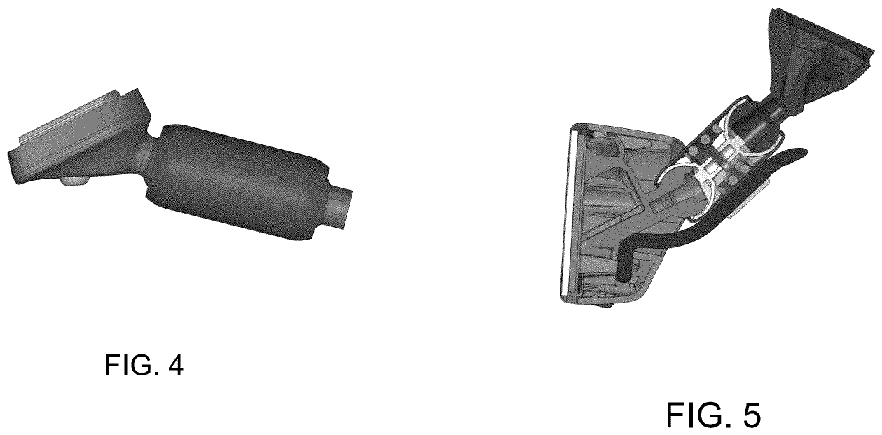

Also, and such as shown in FIGS. 4 and 5, a double ball mount may be provided that has a mounting base that mounts at a mirror mounting button adhesively attached at an in-cabin side of the vehicle windshield, with a mounting arm that pivots relative to the base at a first end of the mounting arm, while the mirror head pivots relative to an opposite second end of the mounting arm. The mirror head may provide the primary pivot while the base provides the secondary pivot. To comply with FMVSS, the mirror may swing out of the way. Such a double ball mount may attach to different mounting buttons, and may allow for vertical adjustment of the mirror head, but may have lower vibration performance compared to the single ball mount constructions. In other words, the double ball mount may be flexible across multiple vehicles and thus may accommodate different windshield angles and mounting configurations.

That is, the two-ball stay allows mirror assemblies to fit most vehicles regardless of windshield angle. However, interior mirror heads are getting heavier as more feature content is integrated into the mirror head (e.g., full display video mirrors, driver monitoring systems with integrated cameras, and the like), which degrades the ability of the two-ball stay to maintain position of the mirror head and resist vibration during vehicle operation. Further, electrical connection between the vehicle wire harness and the mirror head may be routed external the mounting stay.

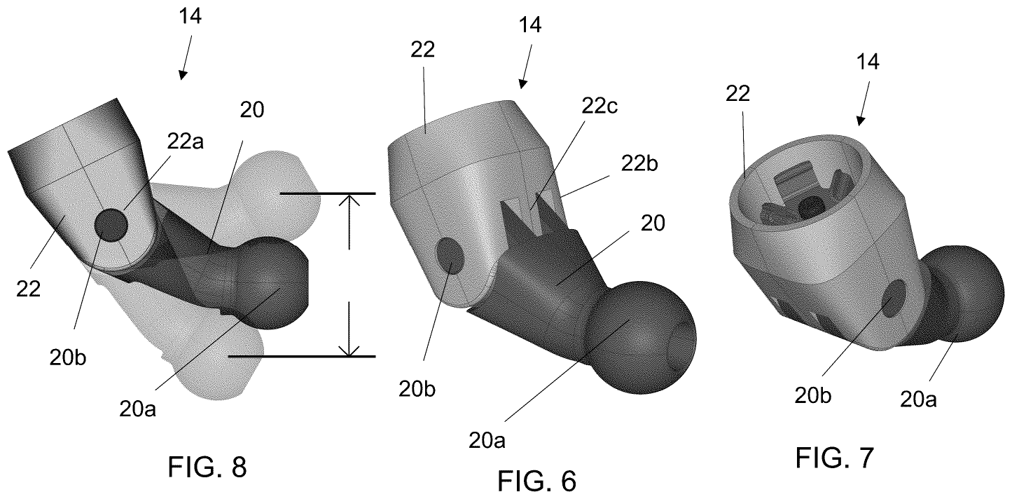

Referring now to FIGS. 4-8, the vertically adjustable single ball mounting assembly 14 is configured to attach at a mounting button or element that is adhesively attached at the in-cabin side of the windshield or that is attached at a headliner of the cabin of the vehicle. The arm 20 includes the ball member 20a at a first end of the arm 20 and an opposite second end of the arm 20 is pivotally attached at the base portion 22, such as via a pair of oppositely protruding pins 20b that are received through or partially through receiving holes or apertures 22a at least partially through opposite walls 22b of the base portion 22. The pins 20b provide for pivoting of the arm 20 relative to the base portion 22 about a single axis (such as a generally horizontal axis when the mirror mount is attached at the interior portion of the vehicle) and prevent pivoting of the arm 20 relative to the base portion 22 about other axes. In other words, the arm 20 is pivoted relative to the base portion 22 via a uni-axial pivot joint that allows for uni-directional or bi-directional pivoting of the arm 20 about the pivot axis (e.g., up and/or down vertical directions about a horizontal pivot axis) and that does not allow for pivoting of the arm 20 about other axes (e.g., pivoting about a vertical axis or other non-horizontal axes).

The arm 20 may include opposite wings or portions 20c extending from the second end of the arm 20 opposite the ball member 20a (with each pin 20b protruding outwardly from a respective wing 20c), and the base portion 22 may include a center guide portion 22c that is received between the wings 20c such that the wings 20c and the outer walls 22b and the center guide portion 22c allow for pivoting of the arm relative to the base portion about the pivot axis and limit or preclude pivoting of the arm relative to the base portion in other directions or about other axes. The pins may protrude outwardly from opposite wings 20c or may comprise a single pin that extends across the arm (whereby the center guide portion of the base portion may be notched to allow the center part of the pin to be received therein). The ball member 20a and the arm 20 may have a passageway formed therethrough for wires to be routed to electrically connect electrical content of the mirror head to a wire harness of the vehicle.

In other words, the wings 20c at the second end of the arm 20 opposite the ball member 20a are at least partially received by the base portion 22, with the center guide portion 22c extending between the wings 20c. The pins 20b extend laterally from the wings 20c and are at least partially received within the apertures 22a extending from inner walls or surfaces of the base portion 22. The pivot axis of the arm 20 is coaxial with a longitudinal axis of the pins 20b. That is, when the arm 20 is pivoted relative to the base portion 22, the arm 20 pivots about the pins 20b which rotate within the apertures 22a of the base portion 22.

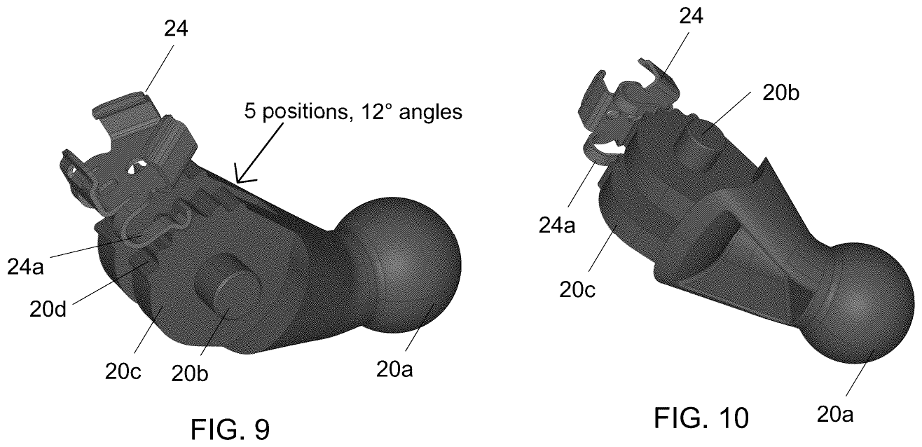

The arm may be pivotable about the horizontal pivot axis in a continual or infinite manner (between an upper limit and a lower limit), or the arm may be positionable at a selected one of multiple discrete positions relative to the base portion. For example, and such as shown in FIGS. 9 and 10, the wings 20c may include a plurality of detents or notches 20d along an inner surface for engagement with a flexible spring tab 24a (or pair of spring tabs) of a mounting element 24 of the vertically adjustable single ball mounting assembly 14. As the arm 20 is pivoted about the pivot axis relative to the base portion 22, the spring tabs 24a move along the surface of the wings 20c and engage respective detents 20d to retain the arm 20 in one of a plurality of positions. The mounting element 24 attaches the mounting structure at a mount or button or element that is attached at the interior portion of the vehicle (such as via snapping onto a tri-lobed element attached at the interior portion of the vehicle). The mounting element may comprise a metallic element that allows for flexing of the mounting element and flexible spring tabs.

When the base portion 22 is attached via the mounting element 24, the spring tab or tabs 24a engages one of the notches 20d at the wing or wings 20c to limit pivotal movement of the arm 20 relative to the base portion 22 and retain the arm 20 and the mirror head 12 in the position relative to the base portion 22. In the illustrated example, the wings 20c have 5 notches or positions, such that each position has the arm 20 pivoted relative to the base portion 22 about 12 degrees From the adjacent position (and thus, the upward and downward pivot range of the arm provides about 60 degrees of vertical adjustment of the arm and ball member and mirror head relative to the base portion, as shown in FIG. 8). However, the wings 20c may have more or fewer notches and/or the notches may be spaced apart at different angle increments. The spring tabs 24a flex to accommodate movement of the wings 20c and notches 20d relative to the spring tabs 24a and to allow for pivotal movement of the arm 20 relative to the base portion 22 when a sufficient upward or downward force is applied at the arm 20 or mirror head 12.

The notches 20d provide for secure retention of the arm 20 at one or more selected positions or angles relative to the base portion 22, such as setting the arm 20 at a desired angle for the particular application or windshield angle at which the mounting assembly 14 is disposed. The spring tab 24a is configured to engage the notches 20d and resist pivotal movement of the arm 20 relative to the base portion 22. The spring force of the spring tab 24a may be selected (such as by selecting different thicknesses or different materials) to provide the desired or appropriate resistance to pivoting of the arm 20 relative to the base portion 22, which limits pivoting of the arm portion 20 relative to the base portion 22 when the driver of the vehicle adjusts the mirror head 12 to adjust his or her rearward view.

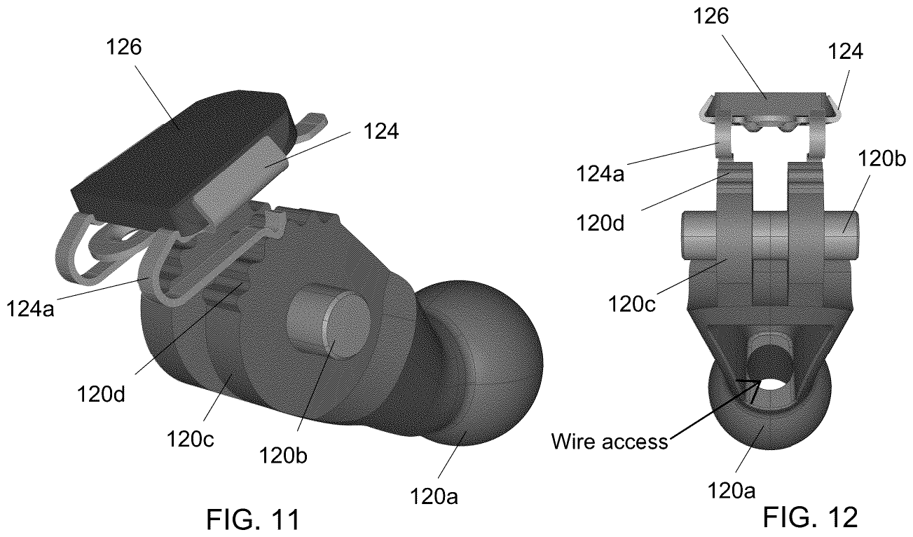

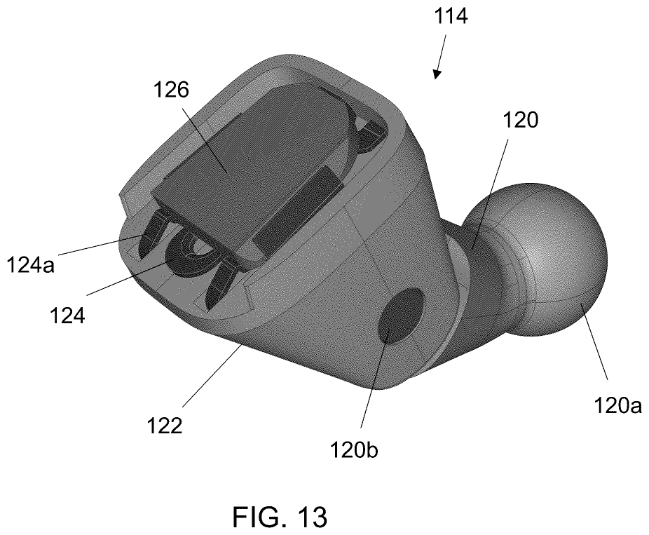

Optionally, the vertically adjustable single ball mounting assembly may be configured to attach to a wedge-shaped mirror mounting button that is adhesively attached at the in-cabin side of the vehicle windshield. For example, and with reference to FIGS. 11-13, a vertically adjustable single ball mounting assembly 114 includes an arm 120 that is pivotally attached at a base portion 122 via one or more pivot pins 120b, such as in a similar manner as described above with respect to the vertically adjustable single ball mounting assembly 14. The pivot pin or pins may protrude outwardly from opposite wings 120c or may comprise a single pin (FIG. 12) that extends across the arm (whereby the center guide portion of the base portion is notched to allow the center part of the pin to be received therein). The base portion 122 has a wedge-mounting element 124 that is configured to slide onto a wedge mount 126 that is adhesively attached at the in-cabin side of the vehicle windshield. The element 124 includes a spring tab 124a (or pair of spring tabs) that is configured to engage the notches 120d of the wings 120c of the base portion 122 to limit pivotal movement of the arm 120 relative to the base portion 122. The mounting element 124 may comprise a metallic element that allows for flexing of the mounting element 124 and flexible spring tabs 124a.

Thus, the vertically adjustable single ball mounting assembly 114 limits vertical pivoting of the arm 120 and ball member 120a and mirror head relative to the base portion 122 via the spring tab 124a engaging the notches 120d as the arm 120 is pivoted relative to the base portion 122 about the pivot axis of the pin 120b. The vertically adjustable single ball mounting assembly provides an integrated spring tab detent and tri-lobe spring or element (or wedge-mount spring or element). Further, a channel or passageway may be formed through the ball member 120a and/or the arm 120 to allow for wired connection between the mirror head and the wire harness of the vehicle along the mounting arm.

Optionally, the mounting assembly may include mating teeth on the upper and lower components. That is, each of the wings of the pivot arm and the mounting base could include teeth that engage one another when the pivot arm is assembled to the mounting base. For example, teeth or detents may be formed on a side surface of the wing that interfaces with an inner surface of the base portion, with corresponding teeth or detents formed on the inner surface of the base portion and configured to face and engage the teeth of the wing. When the arm is positioned at the base portion, the arm may be rotated about the pins to bring the respective teeth into engagement at a desired position of the arm relative to the base portion. The engagement of the respective teeth may limit or preclude the arm from further pivoting relative to the mounting base after assembly, such as by clamping the wings between outer portions of the base portion or using an adhesive between the base portion and wings. That is, the pivot arm may be assembled in the desired position and be fixed. The assembly may have a preset position based on vehicle architecture.

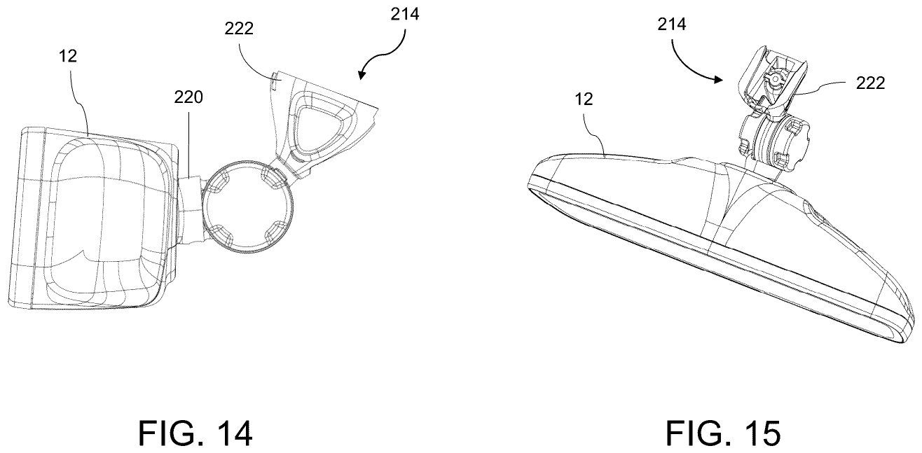

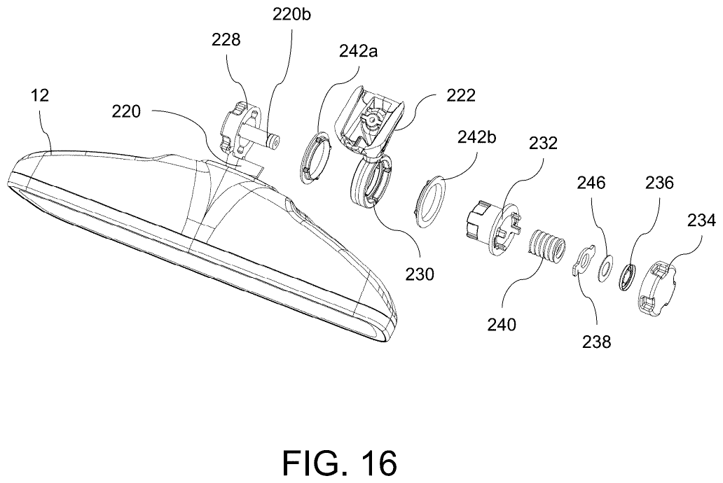

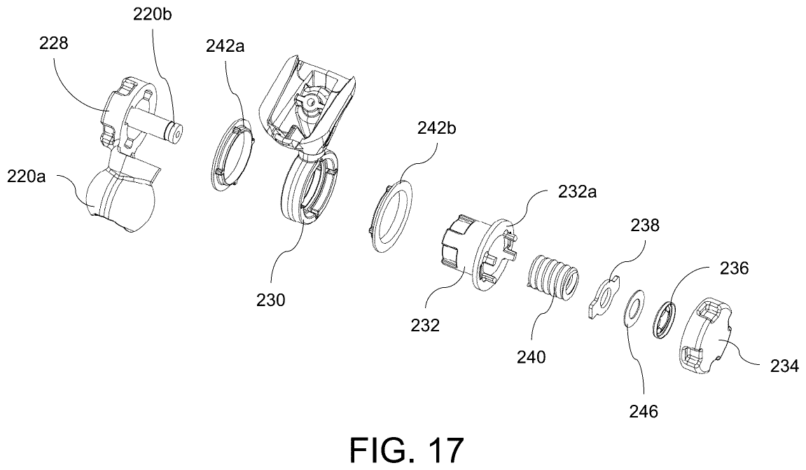

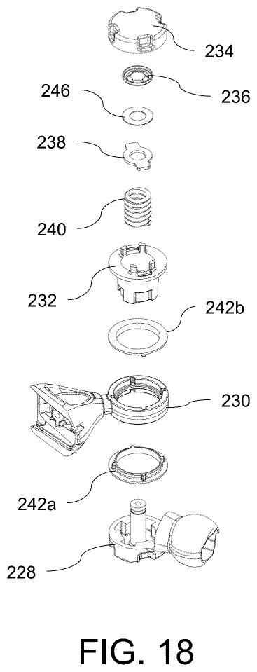

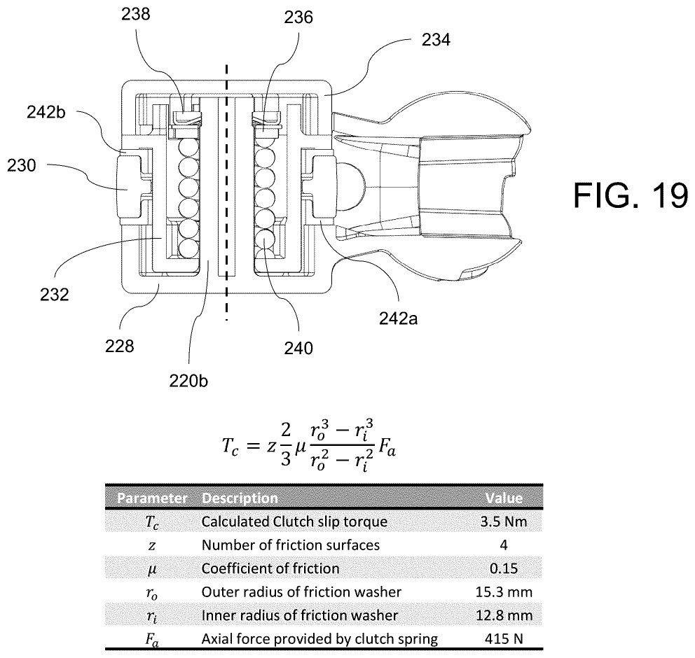

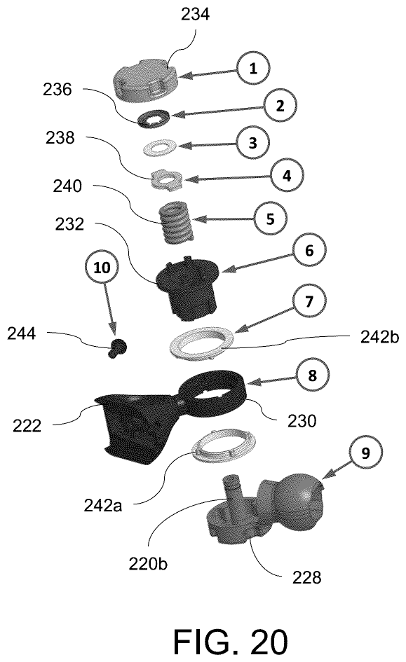

Optionally, a vertically adjustable single ball mounting assembly may be configured to attach to a mirror mounting base where the arm is continually or infinitely pivotable about the horizontal pivot axis (within or between an upper limit and a lower limit) and with a detent mechanism disposed between a wing of the arm and the mounting base that is configured to retain the arm at any suitable pivot position between the upper and lower limits relative to mirror mounting base. For example, and with reference to FIGS. 14-20, a vertically adjustable single ball mounting assembly 214 includes an arm 220 that has a hinge wing 228 extending at an end of the arm 220 opposite the ball member 220a. The ball member 220a is received at the rear of the mirror head 12 to pivotally attach the mirror head 12 to the mounting assembly 214. The hinge wing 228 provides an interface that pivotally mates with a barrel portion 230 of a mounting base 222 configured to attach to the windshield. A pivot pin 220b extends from one side of the hinge wing 228 and is received along a spring cup 232 within the barrel portion 230. A cover 234 is disposed at the side of the barrel portion 230 and spring cup 232 opposite the hinge wing 228 of the arm 220. Thus, the pivot pin 220b extends between the hinge wing 228 and the cover 234 and extends through the barrel portion 230 and the spring cup 232 to pivotally attach the arm 220 and the mirror head 12 relative to the mounting base 222.

A palnut 236 engages a notched end of the pivot pin 220b opposite the hinge wing 228 and a keyed slip washer 238 is disposed between the palnut 236 and an end surface or lip 232a of the spring cup 232 that is opposite the hinge wing 228 to secure the pivot pin 220b along the spring cup 232. In other words, the spring cup 232 is disposed along the pivot pin 220b with the notched end of the pivot pin 220b opposite the hinge wing 228 extending at least partially from the end surface 232a of the spring cup 232. The keyed slip washer 238 is disposed along the pivot pin 220b between the notched end and the end surface 232a and the palnut 236 is secured at the notched end to retain the keyed slip washer 238 along the pivot pin 220b. The keyed slip washer 238 engages the end surface 232a of the spring cup 232 to retain the spring cup 232 along the pivot pin 220b. The spring cup 232 is keyed to the pivotable hinge arm 220, such as via the keyed slip washer 238 engaging and keyed to the spring cup 232 and/or keyed engagement at the hinge wing 228 and thus pivots relative to the barrel portion 230 and mounting base 222 with the arm 220.

Friction washers are keyed to the fixed wedge mount base 222 and engage the hinge wing 228 and/or the spring cup 232 to provide friction interfaces that engage to resist movement of the arm 220 relative to the mounting base 222. A biasing member 240, such as a compression spring, circumscribes the pivot pin 220b and is disposed between the keyed slip washer 238 and an inner surface of the spring cup 232 to bias the hinge wing 228 into engagement with a first friction washer 242a at a first side of the barrel portion 230 and to bias the lip 232a of the spring cup 232 into engagement with a second friction washer 242b at a second side of the barrel portion 230 opposite the first side. That is, with the biasing member 240 between the keyed slip washer 238 and the inner surface of the spring cup 232, the biasing member 240 presses against the keyed slip washer 238 at the end of the pivot pin 220b to bias the wing 228 into engagement with the first friction washer 242a and the biasing member 240 presses against the inner surface of the spring cup 232 to bias the lip 232a of the spring cup 232 into engagement with the second friction washer 242b.

The clamping force from the biasing member 240 and the frictional forces between the respective friction washers and the hinge wing 228 and spring cup 232 pivotally secures the wing 228 relative to the mounting base 222 at selected pivot positions. Thus, during adjustment of the arm 220 about the hinge axis (i.e., about a longitudinal axis of the pivot pin 220b), the clutch or detent mechanism slips about the friction surfaces. In other words, the biasing member 240 biases the hinge wing 228 toward the spring cup 232 and thus biases the hinge wing 228 into engagement with the first friction washer 242a and biases the spring cup 232 into engagement with the second friction washer 242b. The frictional forces between the friction washers and the respective surfaces retains the pivot arm 220 at any suitable pivot position relative to the mounting base 222 when pivot forces are not acting on the mounting assembly 214. When a force is applied to pivot the pivot arm 220 relative to the mounting base 222 (such as a force from a user or an actuator), the force overcomes the frictional forces and the hinge wing 228 slips relative to the first friction washer 242a and the spring cup 232 slips relative to the second friction washer 242b to adjust position of the pivot arm 220 relative to the mounting base 22 until the force is released or until the force is less than the frictional forces.

The mounting base 222 may slidably engage a mounting button disposed at the vehicle windshield and a setscrew 244 may be threadably received at the mounting base 222 to secure the mounting base to the mounting button. A second or non-keyed slip washer 246 may be disposed between the palnut 236 and the keyed slip washer 238.

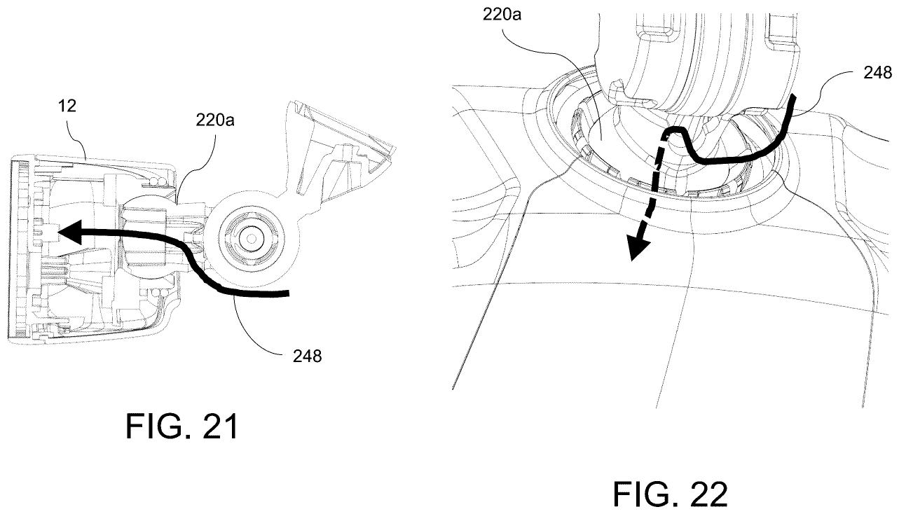

As shown in FIGS. 21 and 22, the wiring 248 for the mirror head 12, such as to electrically connect the mirror head 12 to a power source of the vehicle, may be routed through the arm 220 and/or the ball element 220a. In the illustrated example, the wiring 248 is external the vertically adjustable single ball mounting assembly 214 and may be accommodated within a casing or housing attached at the mounting assembly.

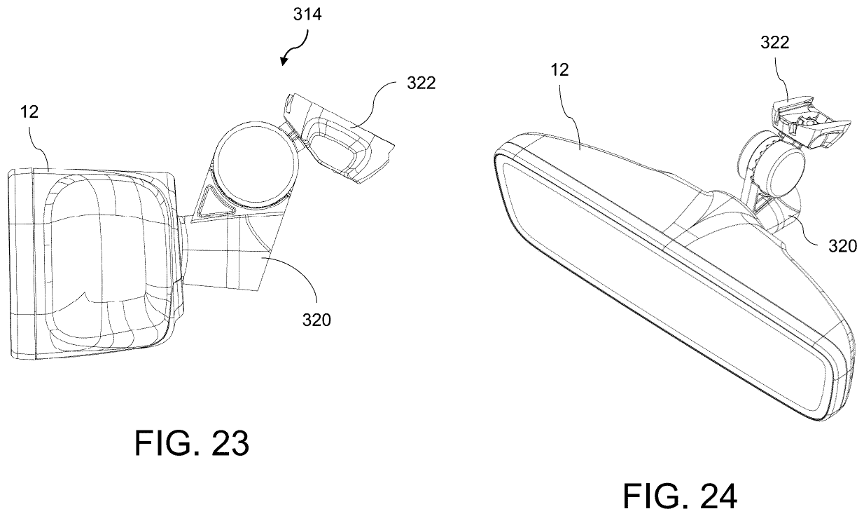

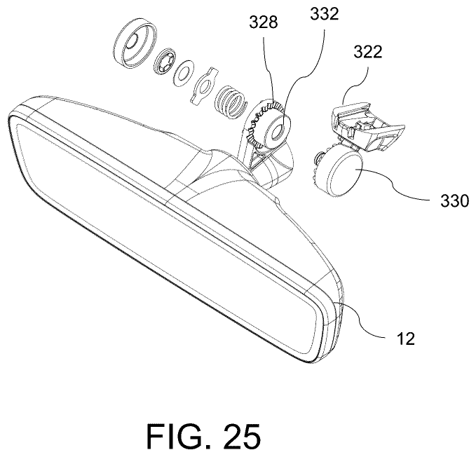

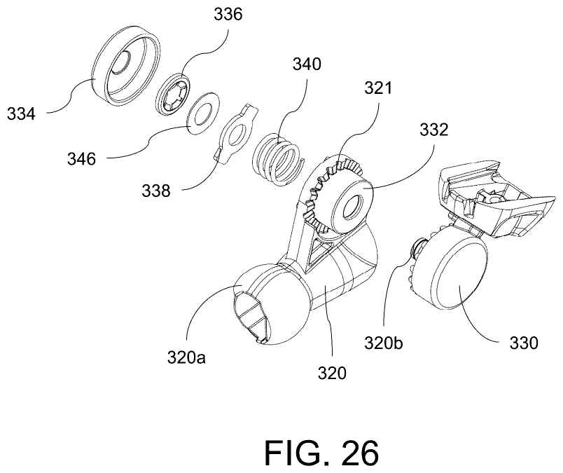

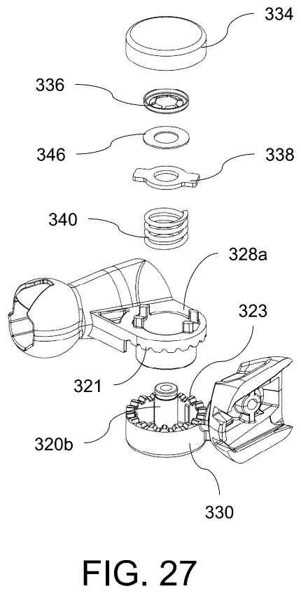

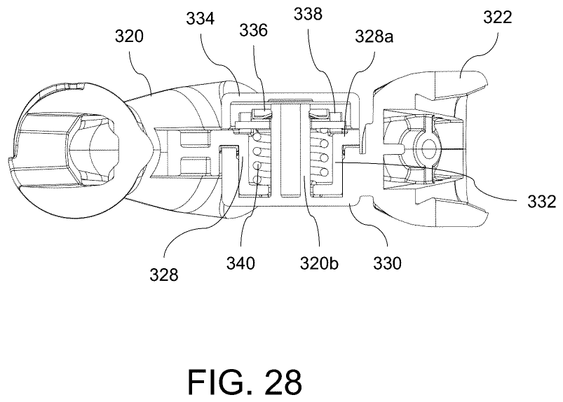

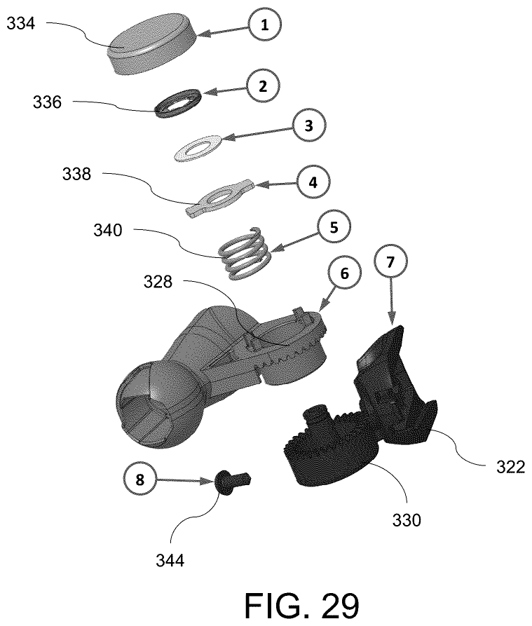

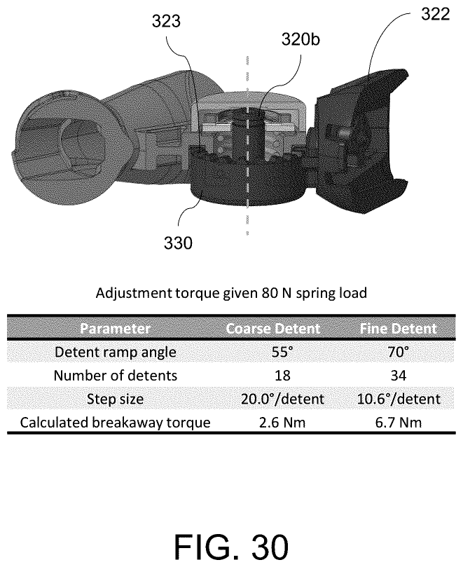

Optionally, the vertically adjustable single ball mounting assembly may be configured to attach to a mirror mounting base where the arm is pivotable relative to the mounting base at selected ones of a plurality of discrete positions relative to the base portion. For example, and with reference to FIGS. 23-30, a vertically adjustable single ball mounting assembly 314 includes a pivot arm 320 and a mounting base 322 where a hinge wing 328 of the pivot arm 320 and a corresponding barrel portion or wing 328 of the mounting base 322 each have teeth that engage one another as the wing 328 pivots relative to the barrel portion 330 to lock the pivot arm 320 (and thus a ball member 320a of the pivot arm 320) at selected pivot positions relative to the mounting base 322. In the illustrated example, a spring cup 332 is integrally formed with the hinge wing 328 of the pivot arm 320 and extends along a pivot pin 320b and the horizontal pivot axis of the mounting assembly 314. The spring cup 332 may be received at least partially within a recess of the barrel 330 of the mounting base 322, with the pivot pin 320b extending from the barrel 330 and along the spring cup 332. Teeth 321 of the pivot arm 320 face teeth 323 of the mounting base 322, with the teeth 321 of the pivot arm 320 extending radially about and circumscribing the spring cup 332 and the teeth 323 of the mounting base 322 extending radially about the pivot pin 320b and circumscribing the recess that receives the spring cup 332 at the barrel 330. The respective teeth of the pivot arm and the mounting base may extend 360 degrees about the pivot axis, or the teeth may be extend only about the pivot axis within a range of motion of the pivot arm relative to the mounting base, such as 180 degrees, 90 degrees, and the like.

A palnut 336 engages a notched end of the pivot pin 320b opposite the barrel 330 and a keyed slip washer 338 is disposed between the palnut 336 and an end surface or lip 328a of the hinge wing 328 to secure the pivot pin 220b along the spring cup 332. The keyed slip washer 338 is keyed with the lip 328a of the hinge wing 328 and thus pivots with the pivot arm 320 about the pivot pin 320b. A cover or end cap 334 is disposed at the lip 328a of the hinge wing 328 and over the palnut 336 and keyed slip washer 338 to close the detent mechanism.

A biasing element 340, such as a compression spring, is disposed about the pivot pin 320b and between the keyed slip washer 338 and an inner surface of the spring cup 332 to bias the wing 328 toward the barrel 330 and thus the teeth 321 of the mounting arm 320 into or toward engagement with the teeth 323 of the mounting base 322. The teeth may be ramped or sloped so that during adjustment of the arm 320 about the hinge axis (i.e., about a longitudinal axis of the pivot pin 320b), the teeth 321 at the pivot arm 320 may ride along the teeth 323 of the mounting base 322. With the pivot arm 320 moved to the desired pivot position, the biasing force from the biasing member 340 precludes the teeth from moving relative to one another and the pivot arm 320 is secured relative to the mounting base 322.

The mounting base 322 may slidably engage a mounting button disposed at the vehicle windshield and a setscrew 344 may be threadably received at the mounting base 322 to secure the mounting base 322 at the mounting button. A second or non-keyed slip washer 346 may be disposed between the palnut 336 and the keyed slip washer 338.

Thus, the wedge mount base 322 is fixed to windshield button. Axial force is provided by the coil spring 340, which forces the pivotable hinge arm 328 into detent features 323 on the base 322. There may be no set “home” position and the mounting arm 320 and the interior mirror head 12 pivot relative to the mounting base 322 in discrete steps.

The number of teeth or detents 321, 323 at the hinge wing 328 of the arm 320 and at the barrel 330 of the base 322 determine the radial distance between each discrete pivot position of the arm 320 relative to the base 322. The angle of the individual teeth or detents determines the torque needed to move the arm 320 relative to the base 322 (such as a manual torque provided by a user or a torque provided by an actuator). That is, the detent interface may include any suitable number of detents or teeth to determine the range of motion between detent positions, with any suitable ramp angle determining the breakaway torque needed to disengage the detent interface. For example, there may be 18 detents with a 20 degree range of motion between each detent position, and each detent may have a 55 degree ramp angle with about 2.6 Newton meters of torque required to disengage the detent interface and move the arm 320 relative to the base 322. Optionally, there may be 34 detents with about a 10.6 degree range of motion between each detent position, and each detent may have a 70 degree ramp angle with about 6.7 Newton meters of torque required to disengage the detent interface and move the arm 320 relative to the base 322.

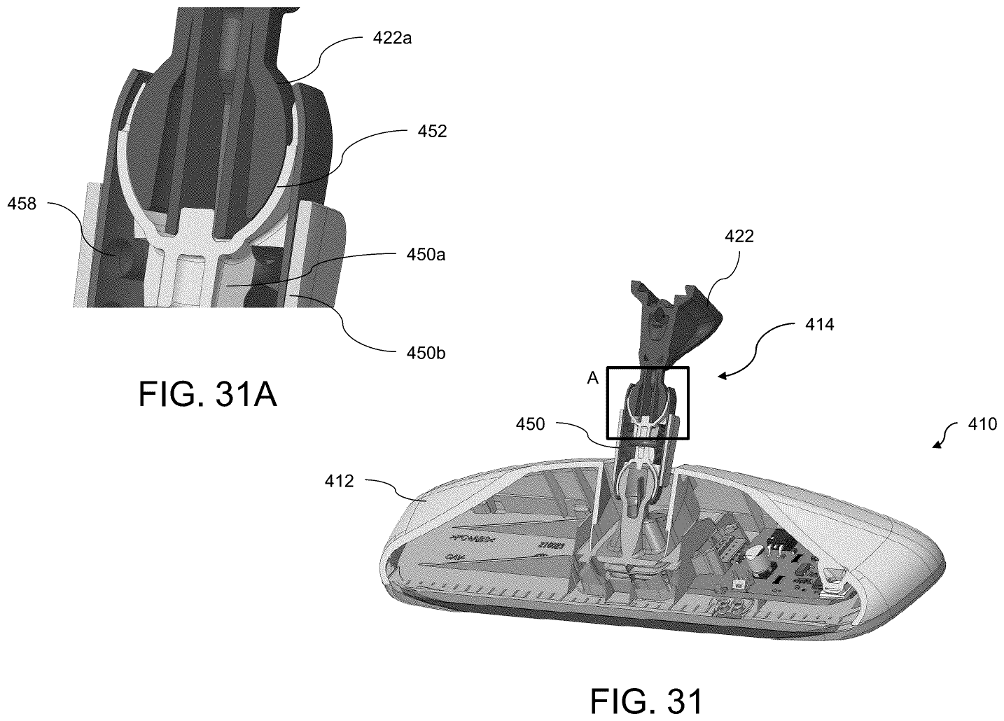

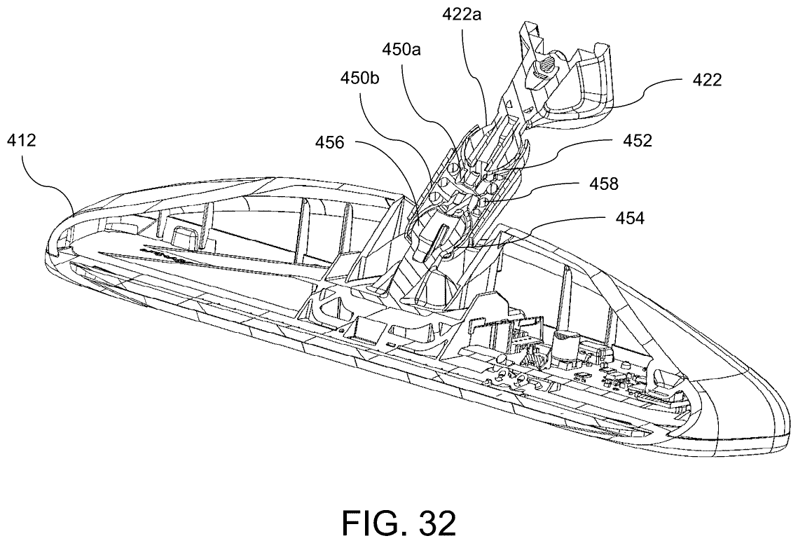

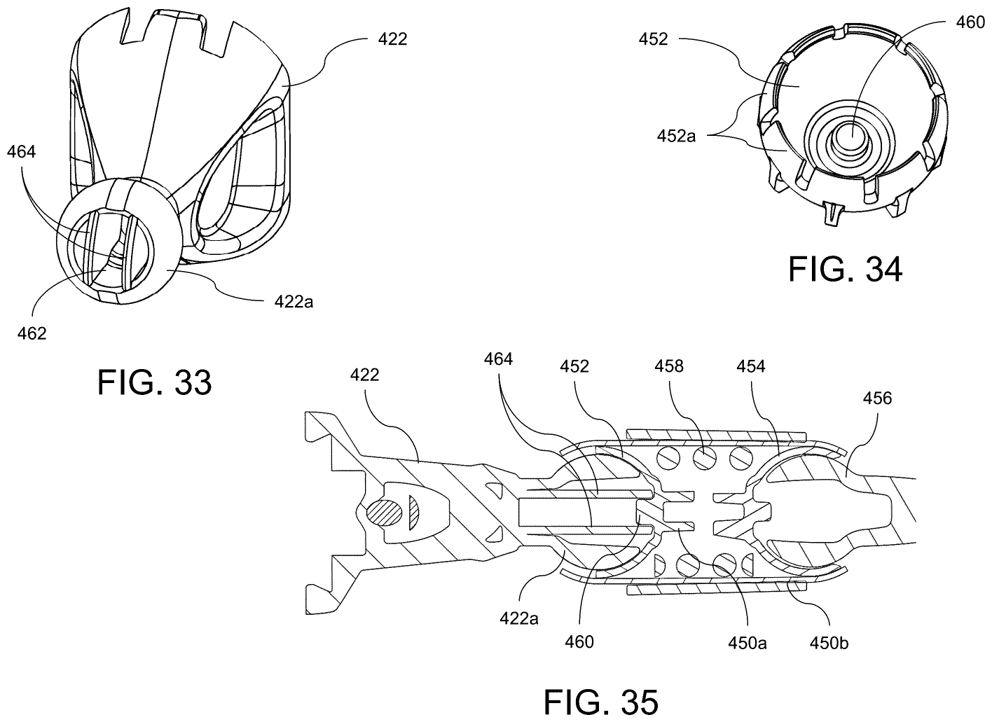

Optionally, the mirror assembly may include a vertically adjustable double ball mount, where movement of at least one of the two ball mounts is limited (e.g., one of the ball joints may only pivot vertically up and down and the ball joint may not pivot horizontally left and right). For example, and as shown in FIGS. 31-35, a mirror assembly 410 includes a mirror head 412 that adjustably mounts to the interior portion of the vehicle via a two-ball mounting assembly or stay 414. The mounting assembly 414 includes a mounting base 422 that mounts at a mirror mounting button attached at the in-cabin side of the vehicle windshield. For example, the mounting base 422 may slidably engage the mounting button and secure to the mounting button via a set screw. The mounting base 422 includes a ball member 422a that is pivotally attached to an arm 450 to form a first ball-and-socket joint of the mounting assembly 414, and the arm 450 is pivotally attached at the mirror head 412 to form a second ball-and-socket joint of the mounting assembly 414. In the illustrated example, the arm 450 includes a first socket 452 at a first end that receives the ball member 422a of the mounting base 422. At a second end of the arm 450 opposite the first end, a second socket 454 of the arm 450 receives a ball member 456 fixed relative to the mirror head 412. Optionally, the second end of the arm 450 may include a ball member that is received within a socket of the mirror head.

The arm 450 may include an inner core or skeletal portion or structure 450a that extends between and defines the first socket 452 and the second socket 454, with an external casing or shell portion or structure 450b that extends along the outer surface of the skeletal structure 450a to provide a smooth outer surface of the arm 450. Further, the first socket 452 is defined by a plurality of flexible sections or protrusions 452a (FIG. 34), and the second socket 454 may be defined by a correspond plurality of flexible sections or protrusions. Thus, when the respective ball members are received at the sockets, the flexible sections flex to accommodate the ball member. A biasing member 458, such as a coil spring, circumscribes the skeletal structure 450a and extends between the outer surface of the first socket 452 and the second socket 454 to bias the flexible sections 452a inward. Thus, with the ball member 422a of the mounting base 420 received in the first socket 452 and the ball member 456 at the mirror head 412 received in the second socket 454, the biasing member 458 provides a retaining force at one or both of the sockets to squeeze the ball members and secure the mirror head 412 and arm 450 in position when pivoted by the user relative to the mounting base 420.

Further, a protrusion or guide 460 is integrally formed with the skeletal structure 450a and extends from an inner surface of the first socket 452 that receives the ball member 420a of the mounting base 420. The ball member 420a includes a recess or hollow portion 462 and, with the ball member 420a received within the first socket 452, the guide 460 extends at least partially into the recess 462 of the ball member 420a. The ball member 420a further includes a pair of ribs 464 extending within the recess 462 along opposing sides of the guide 460. As the arm 450 moves relative to the mounting base 420 (such as when the position of the mirror head is adjusted by the driver) the ribs 464 limit lateral movement of the guide 460 within the recess 462 and thus limit lateral movement or sideward pivoting of the arm 450 relative to the mounting base 420. Optionally, the recess 462 may be formed as a channel, with the guide 460 moving within the channel and the channel limiting lateral movement of the guide 460 relative to the ball member 420a.

In other words, when the guide 460 engages the ribs 464, further movement of the arm 420 is limited. Thus, the ribs 464 may allow the arm 420 to move only along two degrees of freedom (e.g., a vertical upward direction or a vertical downward direction), or the ribs 464 may significantly limit movement of the arm along other degrees of freedom (e.g., movement may be limited in the horizontal left direction and the horizontal right direction). That is, adding ribs to the stay limits the first ball to just two degrees of freedom.

Providing a two pivot joint mounting assembly with the range of motion of at least one of the pivot joints limited allows the mirror assembly to be configured for installation in a variety of different vehicles, such as those having different windshield angles and mounting configurations. Further, the mounting assembly may accommodate heavier mirror heads, such as up to 525 grams or more, with improved vibration performance as the biasing member 458 along the arm 450 resists movement of the mirror head 412 relative to the second socket 454 and resists movement of the arm 450 relative to the mounting base 422 at the first socket 452.

Thus, the mirror assembly provides a two pivot joint solution that accommodates heavy interior rearview mirror heads (such as those that accommodate video display screens and/or DMS) and that is configured to be installed in different vehicles with different windshield angles and/or mounting configurations. The mirror assembly may be interchangeable with a single ball stay and a common mirror head and may mount to the windshield via a standard windshield button. The mirror assembly may utilize a wedge mount with a set screw on the interior cabin side of the windshield with a hinged pivot (e.g., only vertical, up and down rotation) connecting the stay to the wedge mount. At the mirror head, the mirror stay may include a ball member (such as a 28 millimeter ball member) that mates with or is received by a socket at the common mirror head. The neck length of the stay between the pivot joints may be configured to match up with typical swaged tube lengths so as to be interchangeable with different mirror systems. Further, the wire harness and/or coax connections may route through the mirror stay (e.g., between the casing portion and the core portion of the arm) for a fully hidden solution.

The interior rearview mirror mount is thus versatile and adaptable to different vehicles. The mount bridges the gap between single-ball and two-ball stay designs. Further, the mount minimizes the degrees of freedom for movement of the mirror head (such as providing one or more degrees of freedom and four or fewer degrees of freedom). The mount may provide a ball-in design, where the mirror mount includes the ball member received at the mirror head, to be drop-in compatible with single-ball stay designs (where the mirror head may include a socket that receives a ball member of the mounting assembly). The mount may provide a fully hidden wire harness and can support heavy mirror heads (such as weighing up to 525 grams or more).

The vertically adjustable single ball mounting assembly is suitable for heavy interior rearview mirror assemblies (such as mirror assemblies with a full mirror display and/or driver monitoring camera(s) and light emitter(s) and the like), such as mirror assemblies including mirror heads weighing 525 grams or more. A two ball or double pivot joint may be desired to provide a single interior mirror mounting assembly that can mount to most/all vehicles. The vertically adjustable single ball mounting assembly can mount to standard windshield buttons, such as via a wedge mount with set screw on the windshield side, and provides a hinged pivot (only up/down rotation). The ball member may comprise any suitable ball member, such as, for example, a 28 mm ball at the mirror-end of the arm, that pivotally attaches at a socket element at the mirror head to mate with a common mirror head (the “neck” length between pivots may be designed to match up with typical swaged tube lengths so it is interchangeable with various mirror systems). The wire harness and coaxial cables may be routed through the arm and ball member to provide a hidden wire management system.

Thus, the vertically adjustable single ball mounting assembly provides a hinge mount that provides a reduced number of parts as compared to a typical double ball mounting assembly. The vertically adjustable single ball mounting assembly may be suitable for use on multiple vehicle platforms with different windshields having different rake angles. The vertically adjustable single ball mounting assembly may provide increased load handling as compared to typical double ball mounts, and may provide preset or preselected positions for particular applications and settings, if desired.

The reflective element and mirror casing are adjustable relative to a base portion or mounting assembly to adjust the driver's rearward field of view when the mirror assembly is normally mounted at or in the vehicle. A socket or pivot element of the mirror head is configured to receive the ball member of the ball member portion, such as by utilizing aspects of pivot mounting assemblies of the types described in U.S. Pat. Nos. 6,318,870; 6,593,565; 6,690,268; 6,540,193; 4,936,533; 5,820,097; 5,100,095; 7,249,860; 6,877,709; 6,329,925; 7,289,037; 7,249,860 and/or 6,483,438, which are hereby incorporated herein by reference in their entireties).

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184, 190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, or such as a mirror assembly having a prismatic reflective element that is disposed at an outer perimeter edge of the mirror casing and with the prismatic substrate having a curved or beveled outermost exposed perimeter edge, such as described in U.S. Pat. Nos. 9,827,913; 9,174,578; 8,508,831; 8,730,553; 9,598,016 and/or 9,346,403, and/or U.S. Des. Pat. Nos. D633,423; D633,019; D638,761 and/or D647,017, which are hereby incorporated herein by reference in their entireties (and with electrochromic and prismatic mirrors of such construction are commercially available from the assignee of this application under the trade name INFINITY™ mirror).

As discussed above, the mirror assembly may comprise an electro-optic or electrochromic mirror assembly that includes an electro-optic or electrochromic reflective element. The perimeter edges of the reflective element may be encased or encompassed by the perimeter element or portion of the bezel portion to conceal and contain and envelop the perimeter edges of the substrates and the perimeter seal disposed therebetween. The electrochromic mirror element of the electrochromic mirror assembly may utilize the principles disclosed in commonly assigned U.S. Pat. Nos. 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,117,346; 5,724,187; 5,668,663; 5,910,854; 5,142,407 and/or 4,712,879, which are hereby incorporated herein by reference in their entireties.

Optionally, the mirror assembly may comprise a prismatic reflective element. The prismatic mirror assembly may be mounted or attached at an interior portion of a vehicle (such as at an interior surface of a vehicle windshield) via the mounting means described above, and the reflective element may be toggled or flipped or adjusted between its daytime reflectivity position and its nighttime reflectivity position via any suitable toggle means, such as by utilizing aspects of the mirror assemblies described in U.S. Pat. Nos. 6,318,870 and/or 7,249,860, and/or U.S. Publication No. US-2010-0085653, which are hereby incorporated herein by reference in their entireties. Optionally, for example, the interior rearview mirror assembly may comprise a prismatic mirror assembly, such as the types described in U.S. Pat. Nos. 7,289,037; 7,249,860; 6,318,870; 6,598,980; 5,327,288; 4,948,242; 4,826,289; 4,436,371 and/or 4,435,042, which are hereby incorporated herein by reference in their entireties. Optionally, the prismatic reflective element may comprise a conventional prismatic reflective element or prism or may comprise a prismatic reflective element of the types described in U.S. Pat. Nos. 7,420,756; 7,289,037; 7,274,501; 7,249,860; 7,338,177 and/or 7,255,451, which are all hereby incorporated herein by reference in their entireties.

Optionally, the interior mirror assembly comprises a dual-mode interior rearview video mirror that can switch from a traditional reflection mode to a live-video display mode, such as is by utilizing aspects of the mirror assemblies and systems described in U.S. Pat. Nos. 11,242,008; 11,214,199; 10,442,360; 10,421,404; 10,166,924; 10,046,706 and/or 10,029,614, and/or U.S. Publication Nos. US-2021-0162926; US-2021-0155167; US-2020-0377022; US-2019-0258131; US-2019-0146297; US-2019-0118717 and/or US-2017-0355312, which are all hereby incorporated herein by reference in their entireties. The video display screen of the video mirror, when the mirror is in the display mode, may display video images derived from video image data captured by a rearward viewing camera, such as a rearward camera disposed at a center high-mounted stop lamp (CHMSL) location, and/or video image data captured by one or more other cameras at the vehicle, such as side-mounted rearward viewing cameras or the like.

Optionally, the mirror assembly may include a camera or sensor or light of a driver monitoring system and/or head and face direction and position tracking system and/or eye tracking system and/or gesture recognition system. Such head and face direction and/or position tracking systems and/or eye tracking systems and/or gesture recognition systems may utilize aspects of the systems described in U.S. Pat. Nos. 11,582,425; 11,518,401; 10,958,830; 10,065,574; 10,017,114; 9,405,120 and/or 7,914,187, and/or U.S. Publication Nos. US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. patent application Ser. No. 18/508,351, filed Nov. 14, 2023 (Attorney Docket DON01 P4996), and/or U.S. patent application Ser. No. 18/535,183, filed Dec. 11, 2023 (Attorney Docket MAG04 5021), and/or International Publication Nos. WO 2023/220222; WO 2022/241423; WO 2022/187805 and/or WO 2023/034956, which are all hereby incorporated herein by reference in their entireties.

Optionally, the DMS camera may be used to detect ambient light and/or glare light (emanating from headlamps of a trailing vehicle) for use in providing auto-dimming of the EC mirror reflective element. The DMS camera may be disposed in the mirror head and viewing rearward through the mirror reflective element. The processing of image data captured by the DMS camera may be adjusted to accommodate the angle of the mirror head so that the ECU or system, via image processing of image data captured by the DMS camera, determines headlamps of a trailing vehicle (behind the equipped vehicle and traveling in the same direction as the equipped vehicle and traveling in the same traffic lane or in an adjacent traffic lane) to determine glare light at the mirror reflective element. The processing of image data captured by the DMS camera is adjusted to accommodate the degree of dimming of the mirror reflective element. For example, the system knows how much the mirror reflective element is dimmed (responsive to the determined glare light intensity and location) and can accommodate for the mirror dimming level when processing captured image data to determine presence and intensity of light sources/headlamps rearward of the vehicle. The intelligent/automatic mirror dimming functions may utilize aspects of the systems described in U.S. Publication Nos. US-2019-0258131 and/or US-2019-0047475, and/or International Publication No. WO 2022/150826, which are all hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular interior rearview mirror assembly, the vehicular interior rearview mirror assembly comprising:
a mirror head adjustable relative to a mounting assembly, wherein the mirror head accommodates a mirror reflective element;
wherein the mounting assembly is configured to mount the vehicular interior rearview mirror assembly at an interior portion of an interior cabin of a vehicle equipped with the vehicular interior rearview mirror assembly, and wherein the mounting assembly comprises (i) a base portion configured to attach at the interior portion of the interior cabin of the vehicle and (ii) an arm having a pivot element;
wherein the mirror head is adjustably attached at the pivot element of the arm via a ball-and-socket pivot joint;
wherein the arm is pivotally attached at the base portion via a uni-axial pivot joint, and wherein the arm pivots relative to the base portion about a pivot axis of the uni-axial pivot joint;
wherein, with the vehicular interior rearview mirror assembly mounted at the interior portion of the interior cabin of the vehicle, the arm is pivoted relative to the base portion about the pivot axis of the uni-axial pivot joint and the uni-axial pivot joint limits pivoting of the arm relative to the base portion about other axes;
wherein the uni-axial pivot joint comprises a retention mechanism that, with the vehicular interior rearview mirror assembly mounted at the interior portion of the interior cabin of the vehicle, is configured to retain the arm relative to the base portion in a selected position relative to the base portion; and
wherein, with the vehicular interior rearview mirror assembly mounted at the interior portion of the interior cabin of the vehicle, and with the arm retained in the selected position relative to the base portion by the retention mechanism, the mirror head is adjusted by a driver of the vehicle to adjust a rearward view of the driver via pivoting of the mirror head relative to the arm at the ball-and-socket pivot joint.

2. The vehicular interior rearview mirror assembly of claim 1, wherein the retention mechanism comprises a plurality of detents to retain the arm relative to the base portion in a selected one of a plurality of positions relative to the base portion.

3. The vehicular interior rearview mirror assembly of claim 2, wherein the arm comprises a plurality of detent structures and the base portion comprises a flexible tab that engages at least one detent structure of the plurality of detent structures to retain the arm relative to the base portion in the selected one of the plurality of positions relative to the base portion.

4. The vehicular interior rearview mirror assembly of claim 3, wherein the flexible tab is part of a mounting element that attaches the base portion at the interior portion of the interior cabin of the vehicle.

5. The vehicular interior rearview mirror assembly of claim 4, wherein the mounting element attaches the base portion at a wedge-shaped mirror mounting button adhered at an in-cabin side of a windshield of the vehicle.

6. The vehicular interior rearview mirror assembly of claim 4, wherein the mounting element attaches the base portion at a tri-lobe element disposed at one selected from the group consisting of (i) an in-cabin side of a windshield of the vehicle and (ii) a headliner of the vehicle.

7. The vehicular interior rearview mirror assembly of claim 2, wherein the arm comprises a plurality of detent structures and the base portion comprises a plurality of corresponding detent structures that engage the plurality of detent structures of the arm to retain the arm relative to the base portion at the selected one of the plurality of positions relative to the base portion.

8. The vehicular interior rearview mirror assembly of claim 7, wherein a biasing element biases the plurality of detent structures of the arm toward engagement with the plurality of corresponding detent structures of the base portion.

9. The vehicular interior rearview mirror assembly of claim 8, wherein, as the arm pivots relative to the base portion about the pivot axis of the uni-axial pivot joint, the plurality of detent structures of the arm ride along the plurality of corresponding detent structures of the base portion.

10. The vehicular interior rearview mirror assembly of claim 7, wherein the plurality of detent structures of the arm and the plurality of corresponding detent structures of the base portion extend radially about the pivot axis of the uni-axial pivot joint.

11. The vehicular interior rearview mirror assembly of claim 1, wherein the uni-axial pivot joint comprises a pivot pin of the arm that is at least partially received in a receiving portion of the base portion, and wherein the pivot axis of the uni-axial pivot joint extends along a longitudinal axis of the pivot pin.

12. The vehicular interior rearview mirror assembly of claim 11, wherein the retention mechanism comprises a friction interface between the arm and the base portion, and wherein the arm is biased toward engagement with the base portion so that the friction interface retains the arm relative to the base portion in the selected position relative to the base portion, and wherein, as the arm pivots relative to the base portion about the pivot axis of the uni-axial pivot joint, the arm moves relative to the friction interface.

13. The vehicular interior rearview mirror assembly of claim 12, wherein a biasing element is disposed along the pivot pin, and wherein the biasing element biases the arm toward the base portion to engage the friction interface.

14. The vehicular interior rearview mirror assembly of claim 1, wherein, with the vehicular interior rearview mirror assembly mounted at the interior portion of the interior cabin of the vehicle, the pivot axis of the uni-axial pivot joint is oriented horizontally.

15. The vehicular interior rearview mirror assembly of claim 14, wherein, with the vehicular interior rearview mirror assembly mounted at the interior portion of the interior cabin of the vehicle, the retention mechanism is configured to retain the arm relative to the base portion in a selected one of a plurality of vertical positions relative to the base portion.

16. A vehicular interior rearview mirror assembly, the vehicular interior rearview mirror assembly comprising:
a mirror head adjustable relative to a mounting assembly, wherein the mirror head accommodates a mirror reflective element;
wherein the mounting assembly is configured to mount the vehicular interior rearview mirror assembly at an interior portion of an interior cabin of a vehicle equipped with the vehicular interior rearview mirror assembly, and wherein the mounting assembly comprises (i) a base portion configured to attach at the interior portion of the interior cabin of the vehicle and (ii) an arm having a pivot element;
wherein the base portion comprises a first ball member;
wherein a first end of the arm is pivotally attached at the base portion via a uni-axial pivot joint, and wherein the arm comprises a first socket at the first end of the arm, and wherein the first socket receives the first ball member of the base portion to form the uni-axial pivot joint;
wherein the mirror head is adjustably attached at a second end of the arm via a ball-and-socket pivot joint, and wherein the second end of the arm is opposite the first end of the arm;
wherein the arm pivots relative to the base portion about a pivot axis of the uni-axial pivot joint;
wherein, with the vehicular interior rearview mirror assembly mounted at the interior portion of the interior cabin of the vehicle, the arm is pivoted about the pivot axis of the uni-axial pivot joint and the uni-axial pivot joint limits pivoting of the arm relative to the base portion about other axes; and
wherein, with the vehicular interior rearview mirror assembly mounted at the interior portion of the interior cabin of the vehicle, the mirror head is adjusted by a driver of the vehicle to adjust a rearward view of the driver via pivoting of the mirror head relative to the arm at the ball-and-socket pivot joint.

17. The vehicular interior rearview mirror assembly of claim 16, further comprising a biasing element disposed at the arm, wherein, with the vehicular interior rearview mirror assembly mounted at the interior portion of the interior cabin of the vehicle, the biasing element biases the first socket toward engagement with the first ball member to retain the arm relative to the base portion in a selected position relative to the base portion.

18. The vehicular interior rearview mirror assembly of claim 16, wherein the first ball member of the base portion comprises a recessed channel, and wherein a protrusion extending from an inner surface of the first socket is movably received within the recessed channel, and wherein, as the arm pivots relative to the base portion about the pivot axis of the uni-axial pivot joint, the protrusion moves in a direction parallel to a longitudinal axis of the recessed channel, and wherein movement of the protrusion in other directions transverse to the longitudinal axis of the recessed channel is limited to limit pivoting of the arm relative to the base portion about other axes.

19. The vehicular interior rearview mirror assembly of claim 16, wherein the mirror head comprises a second socket, and wherein the arm comprises a second ball member at the second end of the arm, and wherein the second socket receives the second ball member of the arm to form the ball-and-socket pivot joint.

20. The vehicular interior rearview mirror assembly of claim 16, wherein the mirror head comprises a second ball member, and wherein the arm comprises a second socket at the second end of the arm, and wherein the second socket receives the second ball member of the mirror head to form the ball-and-socket pivot joint.

21. The vehicular interior rearview mirror assembly of claim 20, wherein a biasing element biases the second socket toward engagement with the second ball member to retain the mirror head relative to the arm in a selected position relative to the arm.

22. The vehicular interior rearview mirror assembly of claim 16, wherein, with the vehicular interior rearview mirror assembly mounted at the interior portion of the interior cabin of the vehicle, the pivot axis of the uni-axial pivot joint is oriented vertically.

23. A vehicular interior rearview mirror assembly, the vehicular interior rearview mirror assembly comprising:
a mirror head adjustable relative to a mounting assembly, wherein the mirror head accommodates a mirror reflective element;
wherein the mounting assembly is configured to mount the vehicular interior rearview mirror assembly at an interior portion of an interior cabin of a vehicle equipped with the vehicular interior rearview mirror assembly, and wherein the mounting assembly comprises (i) a base portion configured to attach at the interior portion of the interior cabin of the vehicle and (ii) an arm having a pivot element;
wherein the mirror head is adjustably attached at the pivot element of the arm via a ball-and-socket pivot joint;
wherein the arm is pivotally attached at the base portion via a uni-axial pivot joint, and wherein the arm pivots relative to the base portion about a pivot axis of the uni-axial pivot joint;
wherein the uni-axial pivot joint comprises a pivot pin of the arm that is at least partially received in a receiving portion of the base portion, and wherein the pivot axis of the uni-axial pivot joint extends along a longitudinal axis of the pivot pin;
wherein, with the vehicular interior rearview mirror assembly mounted at the interior portion of the interior cabin of the vehicle, the arm is pivoted relative to the base portion about the pivot axis of the uni-axial pivot joint and the uni-axial pivot joint limits pivoting of the arm relative to the base portion about other axes;
wherein the uni-axial pivot joint comprises a retention mechanism that, with the vehicular interior rearview mirror assembly mounted at the interior portion of the interior cabin of the vehicle, is configured to retain the arm relative to the base portion in a selected one of a plurality of positions relative to the base portion;
wherein the retention mechanism comprises (i) a plurality of detent structures at the arm and (ii) a plurality of corresponding detent structures at the base portion, and wherein the plurality of corresponding detent structures of the base portion engage the plurality of detent structures of the arm to retain the arm relative to the base portion at the selected one of the plurality of positions relative to the base portion;
wherein the plurality of detent structures of the arm and the plurality of corresponding detent structures of the base portion extend radially about the pivot axis of the uni-axial pivot joint; and
wherein, with the vehicular interior rearview mirror assembly mounted at the interior portion of the interior cabin of the vehicle, and with the arm retained at the selected one of the plurality of positions relative to the base portion by the retention mechanism, the mirror head is adjusted by a driver of the vehicle to adjust a rearward view of the driver via pivoting of the mirror head relative to the arm at the ball-and-socket pivot joint.

24. The vehicular interior rearview mirror assembly of claim 23, wherein a biasing element biases the plurality of detent structures of the arm toward engagement with the plurality of corresponding detent structures of the base portion.

25. The vehicular interior rearview mirror assembly of claim 23, wherein, as the arm pivots relative to the base portion about the pivot axis of the uni-axial pivot joint, the plurality of detent structures of the arm ride along the plurality of corresponding detent structures of the base portion.

26. The vehicular interior rearview mirror assembly of claim 23, wherein, with the vehicular interior rearview mirror assembly mounted at the interior portion of the interior cabin of the vehicle, the pivot axis of the uni-axial pivot joint is oriented horizontally.

27. The vehicular interior rearview mirror assembly of claim 26, wherein, with the vehicular interior rearview mirror assembly mounted at the interior portion of the interior cabin of the vehicle, the retention mechanism is configured to retain the arm relative to the base portion in a selected one of a plurality of vertical positions relative to the base portion.
